(19) United States
(12) Patent Application Publication
(10) Pub. No.: US 2005/0001156 A1
(43) Pub. Date: Jan. 6, 2005

(54) Rotation detector

(76) Inventors: Minoru Onishi, Nara (JP); Mitsuaki Nakano, Wakayama (JP)

Correspondence Address: BIRCH STEWART KOLASCH & BIRCH, PO BOX 747, FALLS CHURCH, VA, 22040-0747, US

(21) Appl. No.: 10/864,401

(22) Filed: Jun. 10, 2004

(30) Foreign Application Priority Data
Jun. 12, 2003 (JP) 2003-167970

(51) Int. Cl. G01D 5/34

(52) U.S. Cl. 250/231.13; 250/231.16

(57) ABSTRACT

A rotation detector has a rotation disc which is rotatably held on a rotation shaft, a plurality of teeth which are arranged on a surface of the rotation disc along an external periphery thereof, and at least one reflective photocoupler which is positioned slightly away from a surface of the rotation disc and opposed to the teeth. Light is emitted from the reflective photocoupler and impinges on the teeth of the rotation disc 1. The incident light is reflected by the teeth, and impinges on the reflective photocoupler. This rotation detector detects the rotation angle and rotation speed of the rotation disc, based on the receiver's optical outputs. Provision of a second reflective photocoupler enables the device to detect the direction of rotation.

### BACKGROUND OF THE INVENTION

This non-provisional application claims priority under 35 U.S.C. §119(a) on Patent Application No. 2003-167970 filed in Japan on Jun. 12, 2003, the entire contents of which are hereby incorporated by reference.

This invention relates to a rotation detector for detecting the rotation speed, rotation angle and the like of an item.

To give some examples of prior art rotation detectors, Japanese Patent No. 3280554 discloses a rotation detecting sensor which employs a transmissive photocoupler in which a light emitter and a light receiver are opposed to each other. A rotation disc of this sensor has a plurality of teeth formed in its thickness direction. Rotation of the rotation disc causes the teeth to move along their rotary track. The teeth of the rotation disc pass between the light emitter and the light receiver, thereby intermittently blocking an optical path from the light emitter to the light receiver. This rotation detecting sensor detects the rotation speed, rotation angle and the like of the rotation disc, based on the optical output of the light receiver.

FIG. 8 shows the structure of another prior art rotation detector which employs a transmissive photocoupler. A rotation disc 101 of this rotation detector has a plurality of slits 101a formed in its external periphery. The slits 101a pass between a light emitter and a light receiver of a transmissive photocoupler 102. Due to the slits 101a, an optical path from the light emitter to the light receiver is blocked intermittently. This rotation detector detects the rotation speed, rotation angle and the like of the rotation disc 101, based on the optical output of the light receiver.

With respect to the prior art mentioned above, use of a transmissive photocoupler has made it difficult to reduce the size of the rotation detectors.

To be specific, in the rotation detecting sensor disclosed in Japanese Patent No. 3280554, the teeth of the rotation disc pass between the light emitter and the light receiver. This structure requires a clearance between the light emitter and the light receiver. The transmissive photocoupler is large in size, and so is the sensor. Also, since the teeth are formed in the thickness direction of the rotation disc, the optical axis between the light emitter and the light receiver extends parallel to the rotation disc axis. This arrangement necessitates a space dedicated to the optical axis, which also complicates miniaturization of the rotation detection sensor.

Regarding the rotation detector of FIG. 8, the slits 101a in the rotation disc 101 pass between the light emitter and the light receiver of the transmissive photocoupler 102. This structure also requires a clearance between the light emitter and the light receiver. Hence, the transmissive photocoupler is large in size, and so is the rotation detector.

This invention is made in view of these problems found in the prior art. According to the present invention a rotation detector can be reduced in size.

### SUMMARY OF THE INVENTION

A rotation detector according to an embodiment of this invention comprises a rotation disc which is rotatably held on a rotation shaft, a plurality of teeth which are arranged on a surface of the rotation disc along an external periphery thereof, and at least one or more reflective photocouplers which are opposed to the teeth.

With this arrangement, rotation of the rotation disc causes the teeth of the rotation disc to move along a circular track. Since the one or more reflective photocouplers are positioned in alignment with the circular track, each reflective photocoupler can emit light to the teeth of the rotation disc and can receive reflected light from these teeth. In association with the rotation of the teeth, the level of light reflected by the teeth is modulated, and so is the optical output of the receiver in each reflective photocoupler. Based on the receiver's optical output, the rotation detector can detect the rotation speed and rotation angle of the rotation disc.

Since the one or more reflective photocouplers are provided on only one surface of the rotation disc, it is possible to reduce the size of the rotation detector.

In an embodiment of this invention, the rotation disc and the teeth are made of a material which transmits light that is emitted from the one or more reflective photocouplers. A teeth-side surface of the rotation disc is opposite to a surface which faces the one or more reflective photocouplers. According to this rotation detector, light is emitted from each reflective photocoupler and impinges on a surface of a tooth of the rotation disc through the rotation disc. The incident light is reflected by another surface of the tooth and impinges on the reflective photocoupler through the rotation disc.

This arrangement permits the rotation disc to have a flat surface on the reflective photocoupler side, thereby allowing each reflective photocoupler to be placed closer to the rotation disc. As a result, it is possible to reduce the size of the rotation detector of this invention to a further extent.

In another embodiment of this invention, a teeth-side surface of the rotation disc may be face to face with the one or more reflective photocouplers.

According to this arrangement, light is emitted from each reflective photocoupler and impinges on a surface of a tooth of the rotation disc. The incident light is reflected by the surface of the tooth and impinges on the reflective photocoupler.

In various embodiments of this invention, the teeth may be formed in a triangular wave-like pattern or a rectangular wave-like pattern along the external periphery of the rotation disc.

If the teeth have either of these patterns, light reflected by such teeth is modulated to a greater extent, and so is the optical output of the receiver in each reflective photocoupler. Therefore, based on the receiver's optical output, the rotation detector can easily detect the rotation speed and rotation angle of the rotation disc.

In a preferable embodiment of this invention, the rotation detector employs more than one reflective photocoupler, and these reflective photocouplers are so positioned as to produce outputs whose phases are different from each other.

With this arrangement, the phase difference between outputs of the reflective photocouplers is allowed to change depending on the rotation direction of the rotation disc. Hence, based on the phase difference, the rotation detector can detect the rotation direction of the rotation disc.

### BRIEF DESCRIPTION OF THE DRAWINGS

FIG. 1(a) is a top perspective view of a rotation detector according to a first embodiment of this invention. FIG. 1(b) is a bottom perspective view of the rotation detector. FIG. 1(c) is a plan view of the rotation detector. FIG. 1(d) is a side view of the rotation detector.

FIG. 2 is a side view of a reflective photocoupler which is employed in the rotation detector of FIG. 1.

FIG. 3(a) concerns the rotation detector of FIG. 1, illustrating a situation in which a light emitter locates under a projection and a light receiver locates under another projection.

FIG. 3(b) concerns the same rotation detector, illustrating a situation in which a light emitter and a light receiver locate below a same projection.

FIG. 4 is a graph showing variation of an optical output produced by the light receiver in the rotation detector of FIG. 1 while the rotation disc is rotating at a constant speed.

FIG. 5 is a graph showing variation of optical outputs produced by the light receivers of the first and second reflective photocouplers in the rotation detector of FIG. 1.

FIG. 6(a) is a bottom perspective view of the rotation detector according to a second embodiment of this invention.

FIG. 6(b) is a side view of the rotation detector.

FIG. 7(a) concerns the rotation detector of FIG. 6, illustrating a situation in which a reflective photocoupler locates under a recess. FIG. 7(b) concerns the same rotation detector, illustrating a situation in which a reflective photocoupler locates under a projection.

FIG. 8 is a perspective view which represents an example of a prior art rotation detector.

### DESCRIPTION OF PREFERRED EMBODIMENTS

Embodiments of this invention are hereinafter described in detail with reference to the attached drawings.

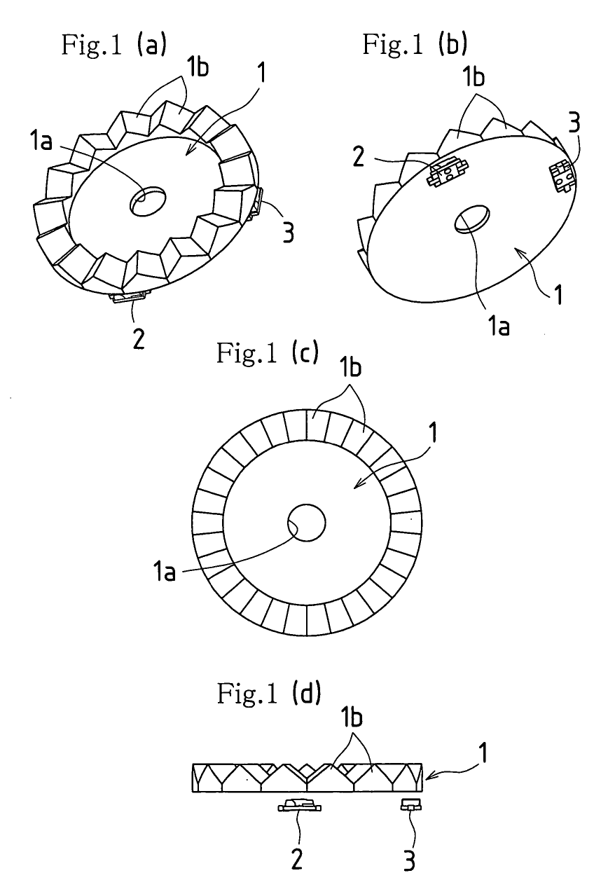

FIGS. 1(a)-(d) concern a first embodiment of the rotation detector according to this invention. FIG. 1(a) is a top perspective view of this rotation detector according to this embodiment. FIG. 1(b) is a bottom perspective view of the rotation detector. FIG. 1(c) is a plan view of the rotation detector. FIG. 1(d) is a side view of the rotation detector.

A rotation detector according to this embodiment has a rotation disc 1, a first reflective photocoupler 2 and a second reflective photocoupler 3. A bore la is formed in the center of the rotation disc 1. The rotation disc 1 is held rotatably on a rotation shaft (not shown) which penetrates through the bore 1a. The rotation disc 1 is made of a material which can transmit light that is emitted from the first and second reflective photocouplers 2, 3.

On a surface (the top surface) of the rotation disc 1, teeth 1b . . . 1b are formed in a triangular wave-like pattern along an external periphery of the rotation disc 1, with projections and recesses alternating at a given pitch. The other surface (the bottom surface) of the rotation disc 1 is flat. The first and second reflective photocouplers 2, 3 are positioned slightly away from the flat bottom surface, being aligned with the teeth 1b . . . 1b.

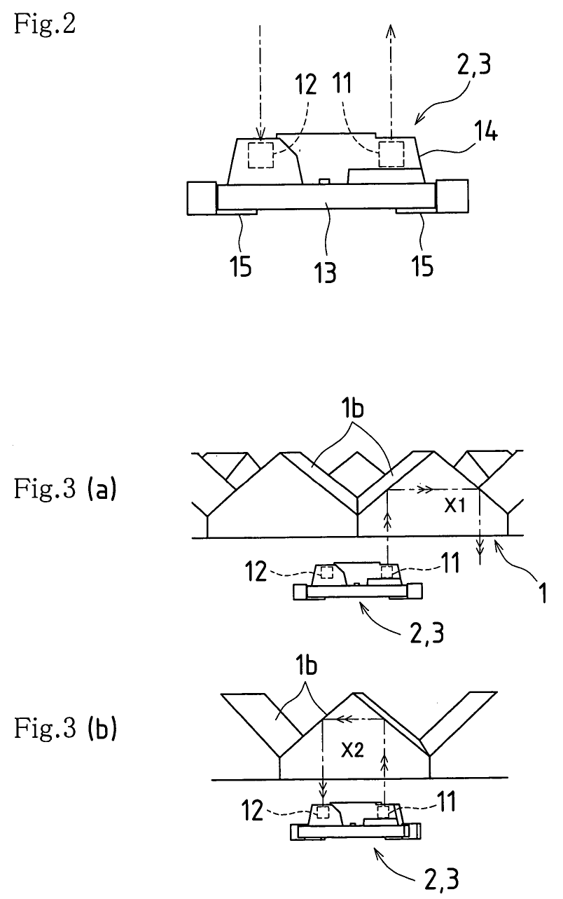

As illustrated in FIG. 2, each of the first and second reflective photocouplers 2, 3 is composed of a substrate 13, a light emitter 11 and a light receiver 12 which are mounted on the substrate 13, a molding resin 14 which encapsulates the light emitter 11 and the light receiver 12, and terminals 15 provided on the back surface of the substrate 13. In both of the first and second reflective photocouplers 2, 3, the terminals 15 are involved in input to the light emitters 11 and output from the light receivers 12.

In the rotation detector of the aforesaid structure, light is emitted from each light emitter 11 and impinges on a surface of a projection of the teeth 1b . . . 1b through the rotation disc 1. The incident light is reflected by surfaces of that projection and impinges on each light receiver 12 through the rotation disc 1. Rotation of the rotation disc 1 causes the teeth 1b . . . 1b of the rotation disc 1 to be displaced relative to the first and second reflective photocouplers 2, 3, so that the incident point for emitted light from each light emitter 11 moves on surfaces of the teeth 1b . . . 1b. While light is reflected by the surfaces of the teeth 1b . . . 1b under such circumstances, each light receiver 12 is to receive different levels of reflected light.

By way of description, reference is made to FIG. 3(a), in which the light emitter 11 is opposed to a projection of the teeth 1b . . . 1b and the light receiver 12 is opposed to another projection thereof. In this situation, light is emitted from the light emitter 11 and is reflected by surfaces of the former projection of the teeth 1b . . . 1b along a path x1. Thus, the reflected light is not incident on the light receiver 12.

On the other hand, FIG. 3(b) illustrates the case where the light emitter 11 and the light receiver 12 are opposed to a same projection of the teeth 1b . . . 1b. In this situation, light is emitted from the light emitter 11 and is reflected by surfaces of that projection of the teeth 1b . . . 1b along a path x2. Thus, the reflected light is incident on the light receiver 12.

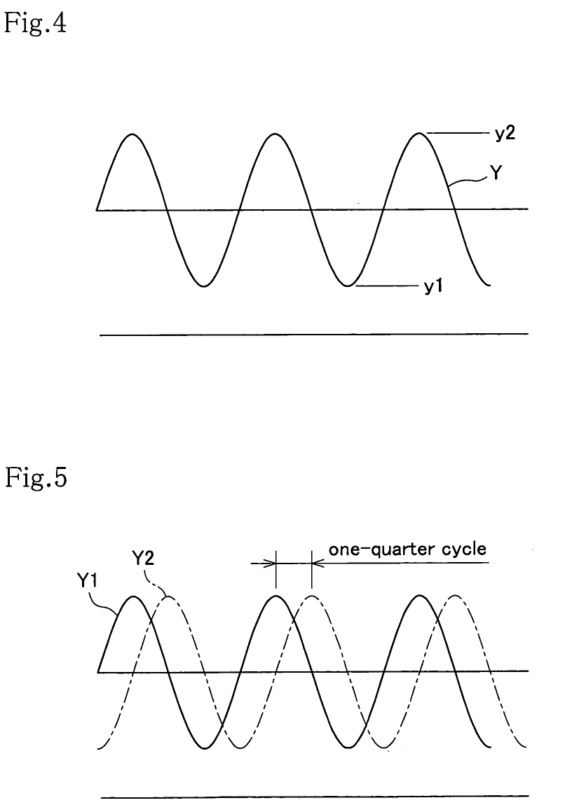

FIG. 4 is a graph showing variation of an optical output of the light receiver 12 while the rotation disc 1 is rotating at a constant speed. As understood from this graph, the optical output Y of the light receiver 12 is represented by a near sine wave. When the light emitter 11, the light receiver 12 and the teeth 1b . . . 1b are positioned as illustrated in FIG. 3(a), the receiver's optical output Y is minimum at y1. In contrast, when the light emitter 11, the light receiver 12 and the teeth 1b . . . 1b are positioned as illustrated in FIG. 3(b), the receiver's optical output Y is maximum at y2.

In this regard, as the rotation angle of the rotation disc 1 increases, phase advance is observed in the receiver's optical outputs of the first and second reflective photocouplers 2, 3. Namely, this phase advance is expressed by the change of optical outputs Y of the light receivers 12 caused by rotation of the rotation disc 1, or expressed by the change of rotation angle which is detectable from the near sine wave.

In addition, as the rotation disc 1 rotates faster, the receivers of the first and second reflective photocouplers 2, 3 produce optical outputs of higher frequency.

Accordingly, the rotation detector can detect the rotation angle and rotation speed of the rotation disc 1 by detecting the phase advance with respect to the receiver's optical output of the first or second reflective photocoupler 2, 3, and by measuring the frequency of the receiver's optical output.

Furthermore, a phase shift between optical outputs Y1, Y2 of the light receivers 12 is obtainable by proper positioning of the first and second reflective photocouplers 2, 3 relative to the teeth 1b . . . 1b. For example, on the rotation disc 1 which has the teeth 1b . . . 1b in a triangular wave-like repeating pattern, imagine a circle whose radius is equal to a distance from each of the reflective photocouplers 2, 3 to the center of rotation for the teeth 1b . . . 1b. The teeth repeat along the circumference of this imaginary circle with a pitch p. The two reflective photocouplers 2, 3 may be spaced along the circumference at a distance which is not a whole number multiple of the pitch p. For example, the two reflective photocouplers 2, 3 may be spaced along the circumference a distance (n×p)+0.25 p. In this relative positional relationship, when the rotation disc 1 rotates in one direction, the light receivers 12 of the first and second reflective photocouplers 2, 3 produce optical outputs Y1, Y2 whose phases are shifted from each other by one-quarter cycle, as shown by the graph of FIG. 5. Further in this relative positional relationship, when the rotation disc 1 rotates in the reverse direction, the light receivers 12 of the first and second reflective photocouplers 2, 3 produce optical outputs Y1, Y2 whose phases are in antiphase and shifted from each other by one-quarter cycle.

Under the relative positional relationship as mentioned above, the rotation detector can detect the rotation direction of the rotation disc 1, based on the phases of receiver's optical outputs Y1, Y2 which are produced by the light receivers 12 of the first and second reflective photocouplers 2, 3.

As described above, in the rotation detector according to the first embodiment, light is emitted from the first and second reflective photocouplers 2, 3 and impinges on certain projections of the teeth 1b . . . 1b of the rotation disc 1. The incident light is reflected by these projections of the teeth 1b . . . 1b and impinges on the first and second reflective photocouplers 2, 3. Based on the receiver's optical outputs of the first and second reflective photocouplers 2, 3, the rotation detector detects the rotation angle, rotation speed, and rotation direction of the rotation disc 1.

In the rotation detector of the first embodiment, the first and second reflective photocouplers 2, 3 are disposed in proximity to each other adjacent one surface of the rotation disc 1. Hence, it is possible to reduce the size of the rotation detector.

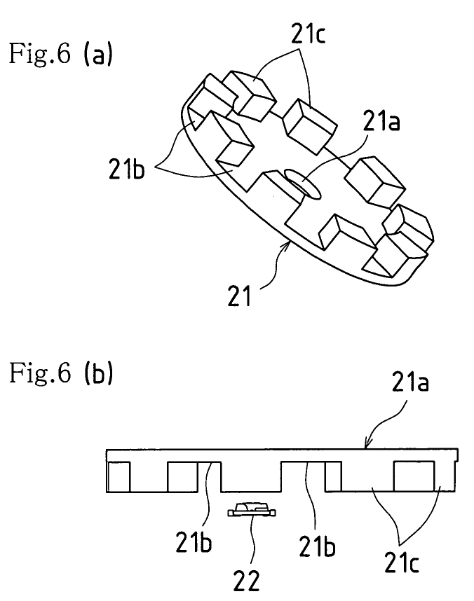

FIG. 6(a) and FIG. 6(b) represent a second embodiment of the rotation detector according to this invention. FIG. 6(a) is a bottom perspective view of a rotation detector according to the second embodiment. FIG. 6(b) is a side view of the rotation detector.

A rotation detector according to the second embodiment has a rotation disc 21 and a reflective photocoupler 22. A bore 21a is formed in the center of the rotation disc 21. The rotation disc 21 is held rotatably on a rotation shaft (not shown) which penetrates through the bore 21a. Light emitted from the reflective photocoupler 22 is reflected on a surface of the rotation disc 21.

On a bottom surface of the rotation disc 21, recesses 21b and projections 21c alternate along its external periphery and constitute teeth 21b, 21c . . . 21b, 21c. The teeth 21b, 21c . . . 21b, 21c present a rectangular wave-like pattern at a given pitch. The reflective photocoupler 22 is positioned slightly away from the projections 21b . . . 21b, being aligned with and opposed to the teeth 21b, 21c . . . 21b, 21c.

The reflective photocoupler 22 has a similar structure to the first and second reflective photocouplers 2, 3 depicted in FIG. 2.

Also in this rotation detector, rotation of the rotation disc 21 causes the teeth 21b, 21c . . . 21b, 21c of the rotation disc 21 to be displaced relative to the reflective photocoupler 22, so that the incident point for the light emitted from the light emitter 11 moves on surfaces of the teeth 21b, 21c . . . 21b, 21c. While light is reflected by the surfaces of the teeth 21b, 21c . . . 21b, 21c under such circumstances, the light receiver 12 is to receive different levels of reflected light.

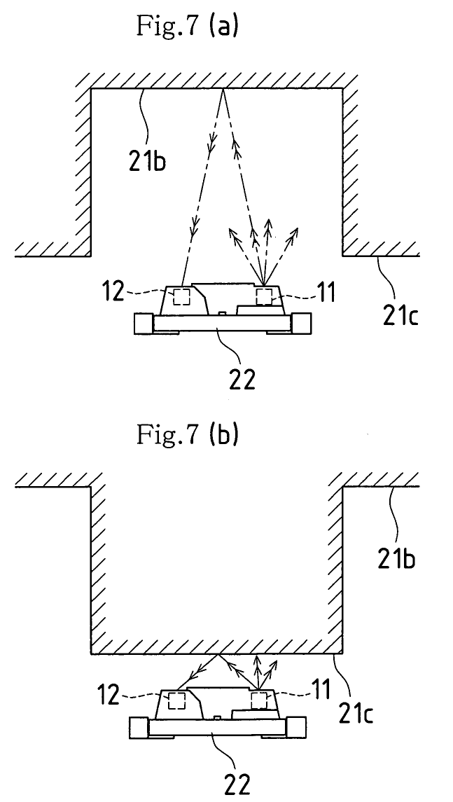

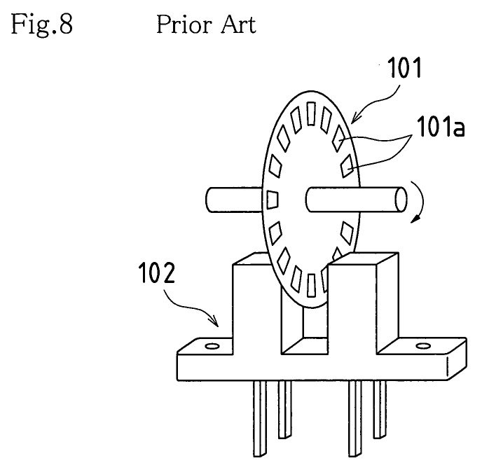

By way of description, FIG. 7(a) shows a situation where the reflective photocoupler 22 locates under one of the recesses 21b. When light is emitted from the light emitter 11, the light is reflected by a surface of the recess 21 band received by the light receiver 12. Because of a long optical path, the reflected light enters the light receiver 12 at a low level.

On the other hand, FIG. 7(b) shows a situation where the reflective photocoupler 22 locates under one of the projections 21c. When light is emitted from the light emitter 11, the light is reflected by a surface of the projection 21c and received by the light receiver 12. Because of a short optical path, the reflected light enters the light receiver 12 at a high level.

Owing to the above-described arrangement, while the rotation disc 21 is rotating at a constant speed, the optical output of the light receiver 12 changes periodically and is represented by a near sine waveform. In this regard, as the rotation angle of the rotation disc 21 increases, phase advance is observed in the receiver's optical output of the reflective photocoupler 22. Also, as the rotation disc 21 rotates faster, the receiver of the reflective photocoupler 22 produces an optical output of higher frequency.

Accordingly, the rotation detector can detect the rotation angle and rotation speed of the rotation disc 21 by detecting the phase advance with respect to the receiver's optical output of the reflective photocoupler 22, and by measuring the frequency of the receiver's optical output.

Similar to the first embodiment mentioned above, the rotation detector according to the second embodiment may be equipped with two reflective photocouplers. These reflective photocouplers are positioned such that their light receivers 12 produce optical outputs whose phases are slightly shifted from each other. Such a rotation detector can detect the rotation direction of the rotation disc 21, based on the phases of optical outputs produced by the light receivers 12 of the reflective photocouplers.

It should be understood that the invention is not limited to the foregoing embodiments, but may be modified in diverse manners. For example, the rotation disc may have teeth in many other patterns. Further, the shape and structure of the reflective photocoupler may be modified variously.

The invention may be embodied in other specific forms without departing from the spirit or essential characteristics thereof. The above embodiments are therefore to be considered in all respects as illustrative and not restrictive, the scope of the invention being indicated by the appended claims rather than by the foregoing description. All changes which come within the meaning and range of equivalency of the claims are therefore intended to be embraced therein.

1. A rotation detector which comprises a rotatable disc, a plurality of teeth arranged on a surface of the rotatable disc along an external periphery thereof, and at least one reflective photocoupler which are opposed to the teeth and positioned entirely on one side of said disc.

2. A rotation detector according to claim 1, wherein the rotatable disc and the teeth are made of a material which transmits light that is emitted from the at least one reflective photocoupler, and said teeth are formed on a surface of the rotatable disc opposite to a surface of the disc which faces the reflective photocoupler.

3. A rotation detector according to claim 1, wherein said teeth are formed on a surface of the disc that is face to face with the reflective photocoupler.

4. A rotation detector according to claim 1, wherein the teeth are formed in a triangular wave-like pattern along the external periphery of the rotation disc.

5. A rotation detector according to claim 1, wherein the teeth are formed in a rectangular wave-like pattern along the external periphery of the rotation disc.

6. A rotation detector according to claim 1, which comprises more than one reflective photocoupler, wherein the reflective photocouplers are so positioned as to produce output signals which are out of phase from each other.
